(19) United States
(12) Patent Application Publication
(10) Pub. No.: US 2006/0047621 A1
(43) Pub. Date: Mar. 2, 2006

(54) Andersonville

(76) Inventor: Steven Kurt Anderson, Marshfield, MA (US)

Correspondence Address: Steven Kurt Anderson, 3 Sunset Lane, Hingham, MA, 02043, US

(21) Appl. No.: 10/927,449

(22) Filed: Aug. 27, 2004

(51) Int. Cl. G06F 17/30

(52) U.S. Cl. 707/1

(57) ABSTRACT

Andersonville's new and scientific addition to our society includes the continuing unity of the United States of America and it's lands and waters. Newborns gaining citizenship at birth will at a bare minimum have the option upon their parent's actions of having their new and unique DNA Profile entered, recorded, and stored within it's Database in case of needed retrieval at the end of the newborn's natural life. This way, if an infant girl born in Presque Isle, Me. is the victim for a coroner twenty-six years later in Yuma, Ariz., the deceased's DNA Profile can be matched with that of the two-day old infant's DNA Profile taken approximately twenty-six years earlier at the delivering hospital in Maine. This would be done if the identity of the victim is unknown in Yuma, Arizona, and Andersonville would easily provide the missing link in the form of the stored DNA Profile on file from when the victim was a newborn. These cities and states are merely examples.

Simply speaking, the invention of Andersonville is a database of DNA information which will contain millions of separate DNA profiles of individuals starting with their first hospital visit at birth. This database of critical information will tie up many loose knots and ends within the law enforcement agencies across the country and world. A human being is granted immediate citizenship after being born within the United States of America. Having this DNA profile of the newborn recorded will, over time, serve as crucial help and always needed organization to the FBI as only one example. The main and/or original purpose of Andersonville is to man the storage of DNA of brand new infants and citizens of the United States of America. The states, counties, cities, and towns of the U.S. are flooded with millions of Jane Does and Jon Does (unidentified, deceased men+women) across are country on a daily basis. In time, this will be a thing of the past, as Andersonville can identify victims of homicidal death, accidental death, or suicides with great speed.

Andersonville can obviously grow and possibly take on other useful roles as they arise such as matching up with DNA to solve a crime. However, Andersonville's main purpose and/or original purpose, as patented, is to serve as crucial storage of the tens of thousands and millions of persons that gain citizenship at birth within our great nation. This is just to say that the benefits of Andersonville will continue to possibly arise, but it's main function is steadfast. With the addition of Andersonville, the problem of the overwhelming abundance of unidentified deceased persons can be reduced beyond what we are used to during the year of circa 2004 as an example. In the decades to come, Andersonville will be able to identify these future victims at death with a DNA sample taken from the deceased. This will become common practice overtime.

Someday, the average person's DNA Profile, recorded confidentially usually within the first week of birth, will be as common as their birth certificate or even their social security number. Unfortunately, even Andersonville must learn to walk before it can run.

Andersonville will eventually be used by the CIA, FBI, President of the United States of America, the United States Military Forces, “America's Most Wanted”, and Law Enforcement Agencies across the U.S. as only a small number of examples. By greatly reducing the amount of unidentified deceased persons located within the U.S., this will also have a flip effect of helping to solve crimes and to “protect and serve” the citizens of this country. An obvious example is that if Andersonville can identify a Jon Doe victim of homicide that would have otherwise slipped thru the cracks and not have been identified because of today's technology, than the deceased's identification would now possibly be able to lead the proper investigators to find out who killed their victim and why. Andersonville will save time and leave many less Jane and Jon Does to work with because of it's benefits. It will take many years for the benefits of Andersonville to take full effect, so the quicker Andersonville is put to use, the better it will be for us all.

Please note that this is just a basic preliminary written document concerning Andersonville, and that, over time, the FBI, CIA, President of the United States, Congress, and the U.S. Government and/or military will have to decide whether or not certain people can waive or agree to have their offspring synchronized in this fashion and/or exactly how Andersonville will be assimilated into today's world the best way possible. There will be many policies and bureaucracies that will have to be covered to affirm that Andersonville will always be used legally and with the interest of the United States people as a whole within it's function. Federal regulation is extremely possible.

Andersonville is named after the inventor and is inspired by another famous Andersonville locked in our country's history, the famous Civil War Prison Camp. If this causes a problem or is against some policy or rule unknown to myself, a new secondary name will be given to this invention. It is not the intention of myself, Steven Kurt Anderson, to “step on anybody's toes” or break any policies. It is my intent to avoid this, as the importance and subsequent use of Andersonville is necessary as soon as possible and already needs to go through many steps as is. I, Steven Kurt Anderson, have thought about not using the name of Andersonville. However, it is the name I have come to call my invention for at least the time being. I am a 29 year old Civil War buff that has great respect for all of the Ghosts of the Civil War conflict whether on the Confederacy or the Union side. Andersonville has some reasons why possibly being called this in it's future.

Andersonville during the Civil War in 1864 was a Confederate Prison Camp that held Union soldiers that were POW's, Prisoners of War. It swelled to great and dangerous proportions after the Southern and Northern soldiers stopped exchanging POW's because the South often times refused to trade back black soldiers to the Union or even keep them alive. This stubborn standstill went on and on. Much blood was spilled within this war prison in a matter of speaking, and much disorganization and lack of hope lived for the members of the camp. Many died. The database named Andersonville will contain much spilled blood also in a matter of speaking. The essence and purpose of Andersonville will provide much organization while also keeping records of importance for citizens of our unified country. Andersonville, the DNA storage database, will be displaying hope in it's intentions on the contrary of the Civil War Prison Camp too. It will unify are towns, cities, and states across the country. The name of Andersonville will also provide a reference to past history, so greater knowledge of our country's history can be learned and understood due to the inspiration where this invention's name partially was drawn from as well. After time passes, Andersonville can be seen as a good word and not immediately bring the thought of tragedy or controversy. Andersonville will solve many crimes and identify many deceased persons with much, much greater accuracy and methods that are used at this time. Decades from now, when millions of unborn American citizens have since gone thru the birthing process and have had their unique DNA profile recorded during their first ever hospital visit, Andersonville will have helped clean up the disorganization and problems that arise from so many unidentified deceased persons throughout our nation. Coroners, homicide detectives, emergency hospital workers, and family members will inevitably see that the process of “cleaning up” the numbers of Jane and Jon Does will occur just from the very existence and presence of Andersonville. With the resources available to us all in the 21st century, the percentage of Jane and Jon Does will be drastically lessened before the end of the century due to the power of Andersonville.

If one does not have to agree to have their baby's DNA entered within the database for it's own safety, there will still be a numerous, numerous amount of women and men which see the benefit of Andersonville, and this is a whole different matter too. All I can do at this point is invent Andersonville, and then the task of integrating it within our society will take place. Men and women alike will come to understand that the storage of their newborn's DNA will provide a trace and future link to their bloodline. They will understand that this will help serve the families of missing or deceased loved ones as only one example. They will appreciate this safety feature. They will know that, heaven forbid that they lose a loved one in the future, the possibility of the truth being found out will greatly outnumber the possibility of not having closure or any knowledge of what happened because of the use of Andersonville. Andersonville will help to minimize unsolved crimes due to it's identifying powers. Someday, after full integration and use of Andersonville, it will just be another invention that is used regularly and possibly even taken for granted by some. Also, Andersonville's very presence will come to help identify Jane or Jon Does that did not enter their DNA into it's database due to the process of elimination. If there DNA Profile is not matched up, then the search will be greatly minimized to the numbers of persons not within the database (possibly someone born long before Andersonville or a foreigner as only two examples). Overtime, years, and decades the number of people's DNA stored in Andersonville will constantly rise and outnumber the percentage of nonusers. This invention is not being made to threaten the privacy of the average Joe; it's database's original and/or main function is to store the identities via DNA profiles of newborns entering this world with their own well-being and interest at hand. The innocence of the infant and now new citizen will remain with Andersonville always. Whatever policies and/or decisions accompany the introduction of Andersonville are just a fact of life. However, it's purpose and benefits are a constant. Overtime, Andersonville will help erase the numerous amount of families that do not know what happened to their loved ones and of those that hope and pray constantly to receive the phonecall that can provide the family with much needed and desired closure. Too often, this phonecall never comes. In essence, Andersonville will simply make our lives easier.

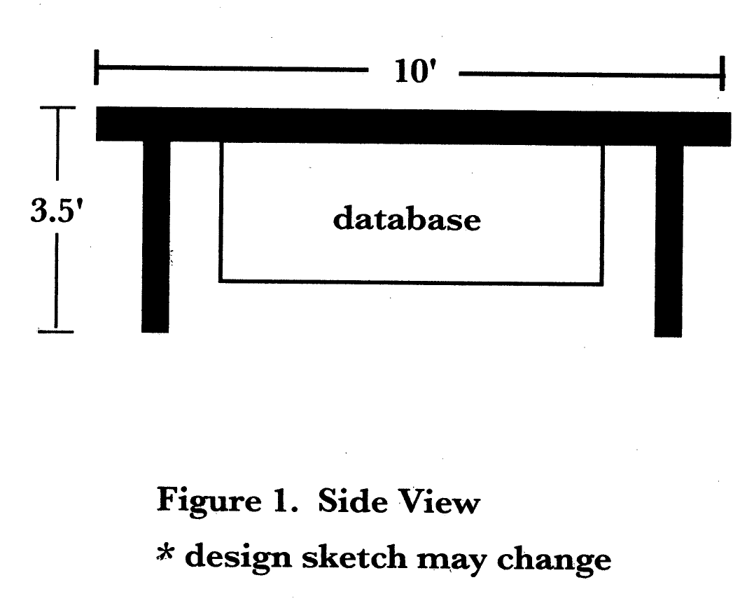

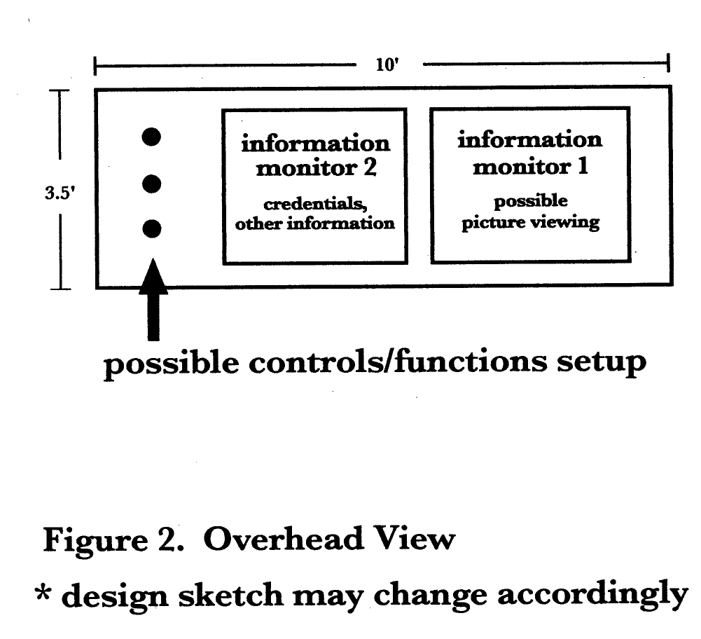

Andersonville will initially be shaped somewhat like an old gurney as an example, such as one that an injured man might have lied on during the Civil War while being carried off the battlefield (please see FIG. 1). It will be flat which could hold a phone or used as a desktop as one small and insignificant example (Please see FIG. 2). It's surface is about 3.5 feet in width all along it's surface, and about 10 feet long from end to end. The surface will be covered with protection of a transparent covering which will be able to disclose information visible to the human eye who is looking down upon it and thru the thin, transparent covering. This covering might be as simple as a computer monitor that you view everyday on your computer. It is just the surface of Andersonville. The database will be underneath the flat surface viewed by it's user, and the database and surface area will be held up by four legs about waist high of an average 6′0″ person. It will be able to be accessed by a person who is of proper authority by viewing images on top of Andersonville.

There will be controls/buttons accessing functions to view DNA matches within the top left side of the gurney's flat surface or desktop surface as well as other functions. As an example, Andersonville could take the entered DNA Profile (DNAP) from a 55 year-old deceased man, and this individual's credentials can then be viewed when Andersonville ‘hits’ or finds the DNA match from when this same person was 3 days old. Please note that it is not as important whether the buttons on Andersonville are on the left or right of it's viewing surface. What is important is it's function, the storage of newborns' unique DNA Profiles just after the newborns' birth within the United States of America. The database can relay data thru a computer, and it might not even have to be viewed on it's surface by the average person who has authority to access pertinent information. This individual might just have information requested relayed to his or her computer within his or her employing office after going thru proper protocol. However, Andersonville itself will be as described within the contents of this specification even if only at a designated location to be accessed from. The point is to have ready and easy access to it's data upon completion and full integration within our society! Andersonville will be a system and invention that will lead us into the future. Therefore, it's design, as stated herein, is important.

At the very least, Andersonville will be a large database regulated by the Federal Government that can have it's motherbase/homebase at a designated location while it's contents can be accessed throughout the nation at particular and authorized agencies and/or relevant organizations. The database which stores the DNA of new American citizens at birth is Andersonville, yet relevant organizations such as a Homicide Division in Portland, Oreg. can attain data needed from what they call “Andersonville” even if it's just data relayed thru another computer within their Bureau. Only time will tell whether there is only one Andersonville or many, many Andersonvilles. This invention will take on a life of it's own, and it will undoubtedly progress and grow thru the years even after our time has come and gone. Obviously, all data and DNA Profiles will be linked and stored with Andersonville no matter what the exact situation. It will work as a whole starting with the Newborn DNA Storage Database(NDNASD) known as Andersonville. Regulations and policies will determine who will enter new DNA profiles within the system as another example.

As an example only, the Jon Doe mentioned above a couple of paragraphs ago could have been born in 2009, and he could've died at 55 during the year of 2064. Andersonville, even without a picture to display, can give you the name of a man that was born in Barrow, Alaska in 2009 and who's identity was completely unknown when his body was found in Detroit, Mich. in 2064. Possibly, this man ran off from home at seventeen or his surviving family has died out. Andersonville will show the hospital, county, state and town of birth, date of birth, credentials such as his blood type, and information regarding his parents on it's top surface. It will do this by the record of the DNA which has been stored for 55 years matching the DNA from the deceased person of 55 years of age.

Please again note that this example of the Alaskan man who perished from natural life as we define it is only an example and of course completely fictitious. A start of a foundation for the invention of what possibly will be called Andersonville is the point of the preceding paragraphs. This invention truly will intertwine itself within are growing economy, technological society, and computerized country. This document is a stepping stone to extreme and fabulous benefits that Andersonville will provide after we have all stopped living the natural life that we live everyday. Like we keep are essence and bloodlines going thru are offspring and continuance of are DNA chain going via are children, grandchildren, and so on, Andersonville will serve as useful storage of our DNA Profiles that we partially+continually pass on everyday to newborns. I am very proud of what I know Andersonville will accomplish over time, and I know that the challenges ahead will strengthen it's resource and place in history. Andersonville will mark my family's name and my name of Steven Kurt Anderson in history, and it will provide a means of income for the family it is proudly named after. This will serve as an initial document regarding some of Andersonville's components, and it will lead to something that will be looked upon with great respect in the years and decades to come.

All of the rights of Andersonville will and do belong to Steven Kurt Anderson, and he will work with the government and many of it's agencies so profit and benefits can be attained thru the invention of Andersonville. The world will now be a better place with our country even more closely unified because of the outstanding power of Andersonville. I know my children or grandchildren born after the use of Andersonville will definitely go thru the Andersonville DNA Record Process(ADNARP). Also, whether someone is born on the shores of Maui, Hi. or in the heart of Texas or on the coast of Nantucket, Mass., their DNA profile will be able to be attained from a Homicide Division's office in San Diego, Calif. or a police station in Lebanon, N.H. or Kenmare, N.Dak. as a few of thousands and thousands of examples. America is one and a team, and together we will work together to organize this country's resources to help make our world a better and safer place to live, flourish, and grow. It is time to start thinking of our country's inevitable future while looking and planning ahead with it's best interest at heart.

1. What I claim as my invention is: a dna profile database that serves as a confidential dna storage base for newborn American citizens born in the united states of America that can be accessed in the years and decades to come by designated authority figures within the field so as to help prevent the numerous additions of unidentified deceased persons throughout the united states of America and it's lands and waters:
I claim: that the invention of Andersonville that is owned and created by Steven Kurt Anderson will probably be regulated via the United States Federal Government and it's personnel; at which time it's complete policies and important networks can be protected and used to help all the peoples of the United States of America as a whole and as one Union.
I claim: that Andersonville's main and/or original purpose which was created and has rights completely owned by Steven Kurt Anderson is to store the new and unique DNA Profiles of newborn babies entering natural life as we describe it that are born as United States Citizens within the United States of America and it's lands and waters; this Database possibly will have a central location that can be accessed with tributary computerized vessels by authorized personnel with a distinct and relevant purpose.
